(19) United States
(12) Patent Application Publication
(10) Pub. No.: US 2026/0010784 A1
(43) Pub. Date: Jan. 8, 2026

(54) COMPUTE-EFFICIENT VECTOR QUANTIZATION IN MACHINE LEARNING MODELS

(71) Applicant: QUALCOMM Incorporated, San Diego, CA (US)

(72) Inventors: Weiliang ZENG, San Diego, CA (US); Marinus Willem VAN BAALEN, Amsterdam (NL); Markus NAGEL, Amsterdam (NL); Paul Nicholas WHATMOUGH, Cambridge, MA (US); An CHEN, San Diego, CA (US); Liang ZHANG, San Diego, CA (US); Chirag Sureshbhai PATEL, San Diego, CA (US); Nilesh Prasad PANDEY, La Jolla, CA (US); Jun MA, San Diego, CA (US); Kevin Lishing HSIEH, San Diego, CA (US); Abhijit KHOBARE, San Diego, CA (US); Joseph Binamira SORIAGA, San Diego, CA (US); Muralidhar Reddy AKULA, San Diego, CA (US); Peter John COUPERUS, Bend, OR (US); Cedric BASTOUL, Geispolsheim (FR)

(21) Appl. No.: 18/762,514

(22) Filed: Jul. 2, 2024

(51) Int. Cl. G06N 3/08

(52) U.S. Cl. CPC G06N 3/08

(57) ABSTRACT

Certain aspects of the present disclosure provide techniques and apparatus for machine learning. In an example method, a weight tensor for a layer of a machine learning model is determined, where the weight tensor comprises per-block values in a first precision encoding. The weight tensor is upscaled to a second precision encoding having a higher precision than the first precision encoding to generate an upscaled weight tensor, and an input tensor for the layer of the machine learning model is accessed. An output tensor for the layer of the machine learning model is generated based on multiplying the upscaled weight tensor with the input tensor.

### INTRODUCTION

Aspects of the present disclosure relate to machine learning.

A wide variety of machine learning model architectures have been trained to perform an assortment of diverse tasks, including computer vision tasks, language tasks, classification and regression tasks, and the like. Recently, research has yielded substantial success in using large models (e.g., deep neural networks, large language models (LLMs), large vison models (LVMs), and the like) to process and generate output data. Often, machine learning models have many parameters (e.g., millions, billions, or even trillions), resulting in significant model size, as well as substantial computational expense in training the model. Further, once trained, such models are often difficult (or impossible) to fine-tune, as the vast number of parameters makes overfitting a major challenge (e.g., potentially relying on tremendous amounts of fine-tuning data to prevent overfitting). Inferencing using such large models is similarly challenging, particularly in resource-constrained devices.

### BRIEF SUMMARY

Certain aspects of the present disclosure provide a processor-implemented method, comprising: determining a weight tensor for a layer of a machine learning model, wherein the weight tensor comprises per-block values in a first precision encoding; upscaling the weight tensor to a second precision encoding having a higher precision than the first precision encoding to generate an upscaled weight tensor; accessing an input tensor for the layer of the machine learning model; and generating an output tensor for the layer of the machine learning model based on multiplying the upscaled weight tensor with the input tensor.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 depicts an example workflow for vector quantized machine learning, according to some aspects of the present disclosure.

FIG. 2 depicts an example workflow for upscaling operations to perform efficient vector quantized machine learning, according to some aspects of the present disclosure.

FIG. 3 depicts an example workflow for per-channel vector quantized machine learning, according to some aspects of the present disclosure.

FIG. 4 is a flow diagram depicting an example method for compute-efficient vector quantized machine learning, according to some aspects of the present disclosure.

FIG. 5 is a flow diagram depicting an example method for vector quantized machine learning, according to some aspects of the present disclosure.

FIG. 6 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved machine learning. Specifically, in some aspects of the present disclosure, techniques for efficient vector quantization are provided.

Quantization has been used to enable efficient machine learning (ML) training and/or inference, particularly on resource-constrained devices (e.g., smartphones, laptops, and the like). Quantization generally involves mapping data (e.g., parameters of a machine learning model, such as the weights) from a first (relatively higher) precision (e.g., floating point) to a second (relatively lower) precision (e.g., integer). In some aspects, quantization may be useful to reduce memory (e.g., dynamic random access memory (DRAM)) bandwidth or usage, reduce memory footprint of the model, increase compute efficiency, and the like. In some cases, effective quantization can enable reduced power consumption and improved model latency. Quantization may be particularly useful for larger models, such as generative artificial intelligence (AI) (e.g., large language models (LLMs), large vision models (LVMs), and the like) on edge devices.

In some aspects, quantization techniques can be generally categorized by their granularity (e.g., whether the parameters are quantized per tensor, per channel, or per block) and/or their grid layout (e.g., uniform (e.g., linear) or non-uniform on one or multiple dimensions). Generally, per-tensor quantization (referred to in some aspects as “tensor-wise quantization”) is the least granular quantization scheme, and involves quantizing an entire tensor (e.g., an entire weight matrix) using the same quantization parameters. Per-channel quantization (referred to in some aspects as “channel-wise quantization”) allows each channel in the tensor to use a unique set of quantization parameters, increasing quantization granularity. Per-block quantization (referred to in some aspects as “block-wise quantization,” “per-group quantization,” and/or “group-wise quantization”) allows blocks or groups elements in the tensor (e.g., a subset of the elements in a given channel and/or across two or more channels, such as a group of sixteen weights in a single channel) to share quantization parameters, with different blocks having (potentially) different parameters (within the same channel and/or across channels).

Vector quantization (VQ) is a non-uniform multi-dimension quantization technique (though VQ can implement uniform quantization, as well as one-dimensional quantization, in some aspects). VQ can provide more flexibility on grid layout, which may translate to improvement on quantized model size and/or accuracy, as compared to other techniques.

In some aspects, the dimensionality (D) of a VQ technique may refer to the number of decoded weights that correspond to each index used, where lower bitwidth indices maps to higher bitwidth weights (or other parameters) on the quantization grid. In some aspects, the grid layout (e.g., centroids of each cell) may be defined based on the parameters in an effort to minimize (or at least reduce) the reconstruction error of the VQ process. In some aspects, VQ can enable an improved tradeoff between model footprint and accuracy (e.g., a similar model footprint to other techniques but with higher accuracy, and/or similar model accuracy to other techniques but with a smaller model size). In some aspects, smaller model footprint can also enable improved latency, as less time is consumed loading weights to and from the processing components.

However, some conventional VQ approaches have substantial challenges in implementation. For example, some conventional VQ techniques cannot be implemented on ML accelerators in a compute-efficient manner (or, in some cases, at all). As another example, some conventional VQ algorithms rely on per-block granularity, which either calls for a custom (hardware) kernel implementation or relies on floating-point (FP) encodings for computation. Though custom kernels may be relatively available for some processors (e.g., graphics processing units (GPUs) and/or central processing units (CPUs)), custom kernels are generally difficult, expensive, and time-consuming to develop for ML accelerators. Further, FP computation is significantly power consuming and compute-inefficient. As a result, some conventional VQ techniques have severely limited potential or applicability on resource-constrained devices.

In some aspects of the present disclosure, compute-efficient VQ that does not rely on a custom kernel (allowing the disclosed techniques to be applied using existing hardware) is provide. Further, in some aspects, the disclosed techniques are computationally efficient (e.g., using integer arithmetic rather than floating point). In some aspects, the VQ techniques can be implemented in a way that constrains the quantization to generate per-channel encodings (rather than per-block), which can be implemented in a significantly more efficient way on existing hardware. In some aspects, the VQ techniques can be implemented with reduced constraints (e.g., not restricted to per-channel encodings) using up-conversion operations during runtime and/or using higher-precision compute, as discussed in more detail below.

### Example Workflow for Vector Quantized Machine Learning

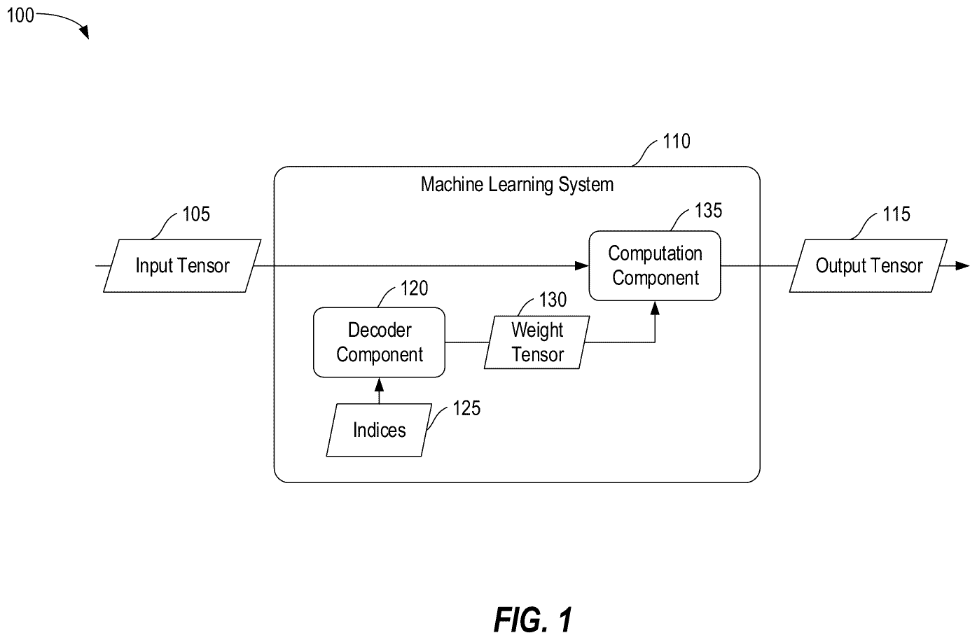

FIG. 1 depicts an example workflow 100 for vector quantized machine learning, according to some aspects of the present disclosure.

In the illustrated example, a machine learning system 110 accesses an input tensor 105 and generates an output tensor 115. As used herein, “accessing” data can generally include receiving, requesting, retrieving, obtaining, generating, collecting, or otherwise gaining access to the data. For example, the machine learning system 110 may receive the input tensor 105 from a client application, or may itself generate the input tensor 105 (e.g., as part of processing data using a machine learning model). In some aspects, the workflow 100 corresponds to a single layer or component of a machine learning model. That is, although the illustrated example depicts the machine learning system 110 receiving the input tensor 105 from an external source and providing the output tensor 115 to an external destination for conceptual clarity, in some aspects, the input tensor 105 may be received from another (upstream) component of the machine learning model (e.g., the prior layer) and the output tensor 115 may be provided to another (downstream) component of the machine learning model (e.g., the subsequent layer).

As illustrated, the input tensor 105 is accessed by a computation component 135 to generate the output tensor 115. Further, a set of indices 125 are processed by a decoder component 120 to generate a weight tensor 130, which is also accessed by the computation component 135. The indices 125 generally represent or indicate the (quantized) parameters of the operation. As discussed above, using vector quantization techniques, each index in the set of indices 125 may correspond to multiple parameters. For example, in the case of two dimensional vector quantization, each index 125 may map to two parameters (e.g., weights in the weight tensor 130). In some aspects, the indices 125 have a first bitwidth (e.g., six bits) and map to multiple weights (e.g., two weights per index) having a second bitwidth (e.g., eight bits per weight). That is, for example, 128 indices (each six bits long) may be used to identify 256 weights (each eight bits long).

In some aspects, the decoder component 120 uses a codebook (e.g., a look-up table (LUT)) to generate the weight tensor 130 based on the indices 125. In some aspects, the codebook comprises or indicates the weights in a non-uniform distribution. For example, as discussed above, during model quantization the quantizing system (which may be the machine learning system 110 or may be a different system) can determine the (potentially non-uniform) quantization grid that best fits the (non-quantized) model parameters. The machine learning system 110 can then generate the indices 125 and a codebook indicating the parameter(s) that correspond to each index. Generally, the decoder component 120 may use vector quantization of any dimensionality and may include uniform or non-uniform distributions of weights (e.g., including one dimension (where each index maps to a single weight), two dimensions (where each index maps to two weights), three dimensions (where each index maps to three weights), and so on).

In some aspects, the indices 125 are generally stored in a lower bitwidth than the weight tensor 130. For example, as discussed above, the indices 125 may each be encoded in a first precision encoding (e.g., integer values encoded in a first bitwidth, such as six bits), while the weights in the weight tensor 130 may each be encoded in a second precision encoding (e.g., integer values or floating-point values encoded in a second bitwidth, such as eight (or more) bits).

In some aspects, rather than using a codebook to generate the weight tensor 130, the decoder component 120 may use other techniques depending on the particular implementation. For example, if a one dimensional uniform quantization scheme is used (with per block quantization granularity), the decoder component 120 need not rely on a codebook, and may instead use other techniques such as an affine function to derive the weights in the weight tensor 130 based on the indices 125. The same affine function may be applied to all blocks to obtain the weight tensor 130 in such an implementation.

As illustrated, the computation component 135 can then generate the output tensor 115 based on the input tensor 105 and the decoded weight tensor 130. For example, in some aspects, the computation component 135 may perform per-channel matrix multiplication between the input tensor 105 and the weight tensor 130. In some aspects, as discussed above, the weights in the weight tensor 130 may be encoded in a first precision (e.g., eight-bit integer or sixteen-bit floating point). In some aspects, the input tensor 105 and output tensor 115 may be encoded in a relatively high precision (e.g., sixteen bits integer or floating point). In some aspects, using integer encodings can substantially reduce the computational expense of the computation component 135.

As discussed above, although the illustrated example depicts an external source of the input tensor 105 and an external destination of the output tensor 115 for conceptual clarity, in some aspects, the illustrated workflow 100 may correspond to a single component (e.g., a single layer) in a machine learning model. That is, the input tensor 105 may be the input tensor for a given layer of the model, while the output tensor 115 is the output of the given layer and the weight tensor corresponds to the given layer (determined using indices 125 and/or a codebook or affine function specific to the given layer).

Advantageously, using the workflow 100, vector quantization can be applied to reduce model footprint and computational expense without relying on custom kernels or other hardware. Further, in some aspects, the disclosed techniques enable integer computations to be performed, substantially reducing power consumption and compute time during runtime.

### Example Workflow for Upscaling Operations to Perform Efficient Vector Quantized Machine Learning

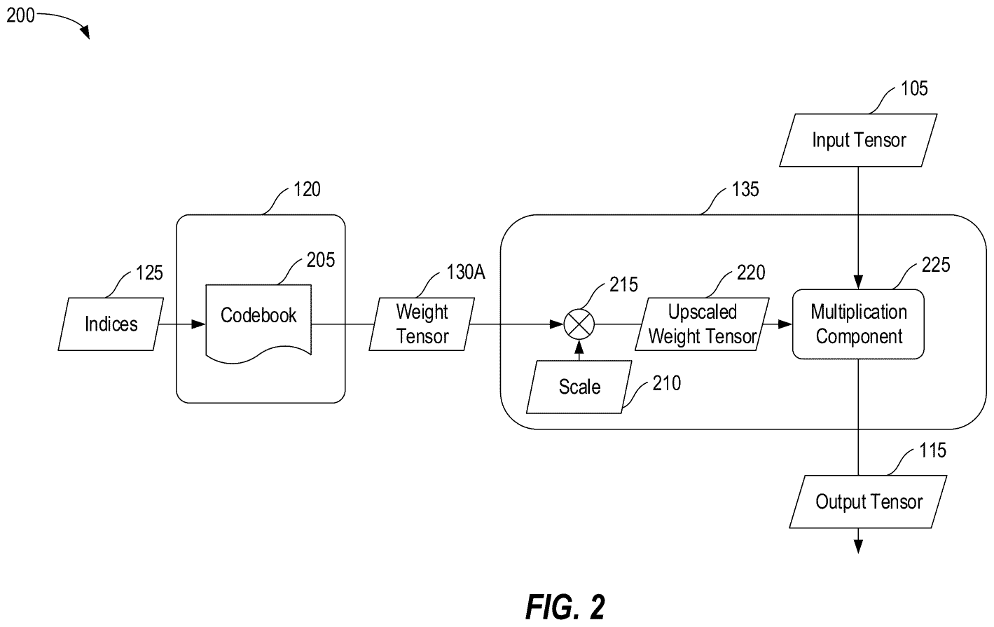

FIG. 2 depicts an example workflow 200 for upscaling operations to perform efficient vector quantized machine learning, according to some aspects of the present disclosure. In some aspects, the workflow 200 may be performed by a machine learning system, such as the machine learning system 110 of FIG. 1.

In the illustrated example, the decoder component 120 uses the set of indices 125 to identify, from a codebook 205, the weight tensor 130A. As discussed above, in some aspects, the indices 125 each indicate or map to one or more parameters (e.g., weights) in the codebook 205. For example, as discussed above, each index 125 may map to one, two, or more weights. In some aspects, as discussed above, the weights in the weight tensor 130A may be encoded in a first precision (e.g., eight-bit integer). Although not depicted in the illustrated example, in some aspects, the decoder component 120 may use an affine function or other technique, rather than the codebook 205, to generate the weight tensor 130A (e.g., in the case of uniform one-dimensional quantization).

In some aspects, the weight tensor 130A corresponds to per-block quantization. That is, during quantization of the model, the quantization system (which may or may not be the same system as the machine learning system) may determine unique quantization parameters for each unique block or group of weights (e.g., for each N×M subarray in the matrix of weights. As discussed above, many VQ approaches use per-block quantization (e.g., per-block indices 125 that can be used to determine, from a per-block codebook 205 or other function, a set of per-block quantized weights).

In the illustrated example, the weight tensor 130A is processed by an up-conversion operation 215 based on a scale 210 to generate an upscaled weight tensor 220. In some aspects, the scale 210 comprises per-block scales (where each block in the weight tensor 130A may be upscaled by the same amount or by different amounts). In some aspects, the scale(s) 210 are defined to convert the weight tensor 130A from per-block quantization to per-channel quantization. That is, while the weight tensor 130A may be quantized per-block, the upscaled weight tensor 220 may be quantized per-channel.

Generally, per-block encoding indicates that each block (of the weight tensor 130A) can use a corresponding scaling factor, while per-channel encoding indicates that each channel (which may have many blocks) uses a single scaling factor. The up-conversion operation 215 enables the per-block data (e.g., four-bit values with individual scaling factors) to be converted to per-channel data (e.g., eight bit values with a single scaling factor), enabling further computation without a customized kernel.

In some aspects, the upscaled weight tensor 220 may have a higher precision than the weight tensor 130A. For example, if the weight tensor 130A has an eight-bit integer encoding, the weight tensor 220 may have a sixteen-bit integer encoding. In some aspects, rather than integer encoding, the weight tensor 220 may have a sixteen-bit floating-point encoding.

In the illustrated example, the upscaled weight tensor 220 is then processed, by a multiplication component 225, to generate an output tensor 115 based on the input tensor 105. For example, as discussed above, the multiplication component 225 may perform per-channel matrix multiplication (e.g., using the upscaled weight tensor 220 encoded in sixteen-bit precision and the input tensor 105 encoded in sixteen-bit precision).

Advantageously, by upscaling the weight tensor 130A from block-wise quantization (generated by the vector quantization scheme) to a per-channel upscaled weight tensor 220, the machine learning system can enable vector quantization to be readily implemented using current accelerator hardware, without relying on custom kernels or hardware modifications.

### Example Workflow for Per-Channel Vector Quantized Machine Learning

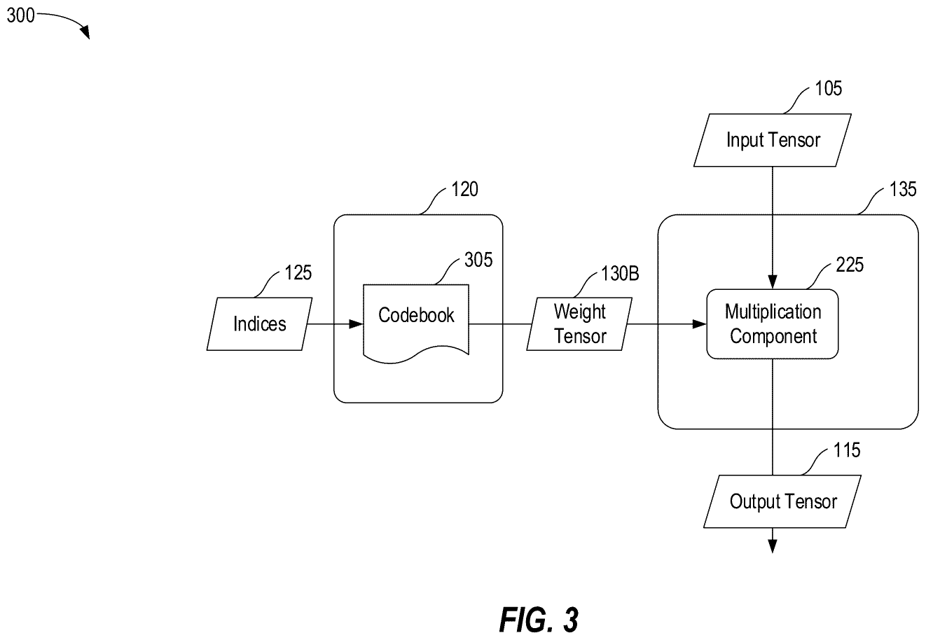

FIG. 3 depicts an example workflow 300 for per-channel vector quantized machine learning, according to some aspects of the present disclosure. In some aspects, the workflow 300 may be performed by a machine learning system, such as the machine learning system 110 of FIG. 1, and/or the machine learning system discussed above with reference to FIG. 2.

In the illustrated example, the decoder component 120 uses the set of indices 125 to identify, from a codebook 305, a weight tensor 130B. As discussed above, in some aspects, the indices 125 each indicate or map to one or more parameters (e.g., weights) in the codebook 305. For example, as discussed above, each index 125 may map to two or more weights. In some aspects, as discussed above, the weights in the weight tensor 130B may be encoded in a first precision (e.g., eight-bit integer). Although not depicted in the illustrated example, in some aspects, the decoder component 120 may use an affine function or other technique, rather than the codebook 305, to generate the weight tensor 130B (e.g., in the case of uniform one-dimensional quantization).

In some aspects, the weight tensor 130B corresponds to per-channel quantization. That is, during quantization of the model, the quantization system (which may or may not be the same system as the machine learning system) may use vector quantization constrained to generate a per-block codebook 305 and per-block indices 125, but a per-channel quantization encoding for the weights.

Generally, this per-channel encoding constraint may be implemented in a variety of ways. For example, in some aspects, the quantization system may determine per-channel quantization parameters (e.g., by aggregating or averaging the per-block parameters for the blocks in the channel) and then fix or set the per-block parameters of each included block to the determined per-channel parameters. As another example, the quantization system may iterate over the blocks and independently optimize the codebook 305 and indices 125 to generate per-channel parameter encodings.

In some aspects, the weight tensor 130B may have a precision such as an eight-bit integer encoding. In the illustrated example, the weight tensor 130B is then processed, by a multiplication component 225, to generate an output tensor 115 based on the input tensor 105. For example, as discussed above, the multiplication component 225 may perform per-channel matrix multiplication (e.g., using the weight tensor 130B encoded in eight-bit precision and the input tensor 105 encoded in sixteen-bit precision).

Advantageously, by constraining the quantization process to generate a per-channel quantized weight tensor 130B, the machine learning system can enable vector quantization to be readily implemented using current accelerator hardware without relying on custom kernels or hardware modifications.

### Example Method for Compute-Efficient Vector Quantized Machine Learning

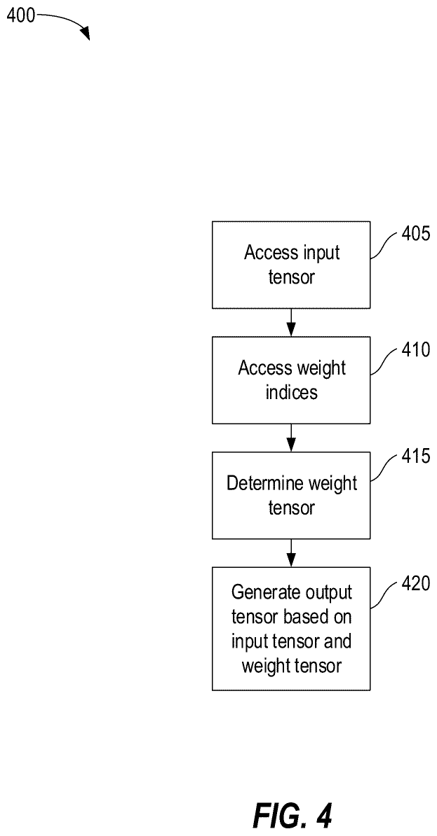

FIG. 4 is a flow diagram depicting an example method 400 for compute-efficient vector quantized machine learning, according to some aspects of the present disclosure. In some aspects, the method 400 may be performed by a machine learning system, such as the machine learning system 110 of FIG. 1, and/or the machine learning system discussed above with reference to FIG. 2 and/or FIG. 3.

At block 405, the machine learning system accesses an input tensor to a layer (or other component) of a machine learning model (e.g., the input tensor 105 of FIGS. 1-3). In some aspects, the input tensor may be referred to as an “activation tensor” (or a set of activations) to indicate that the input tensor was generated as output from an activation function of the prior layer or component in the machine learning model. Generally, the input tensor corresponds to any data being processed by the model (e.g., based on input from a user or client application).

At block 410, the machine learning system accesses a set of weight (or other parameter) indices for the layer (or other component) of the machine learning model (e.g., the indices 125 of FIGS. 1-3). In some aspects, as discussed above, the weight indices are generated as part of a vector quantization operation, where each index may map to one or more weights in a uniform or non-uniform distribution, depending on the particular implementation.

At block 415, the machine learning system determines a weight (or other parameter) tensor for the layer (or other component) of the machine learning model based on the weight indices. Generally, the particular operations used to determine the weight tensor may vary depending on the particular implementation. For example, in some aspects, the machine learning system may search a codebook (e.g., the codebook 205 of FIG. 2 and/or the codebook 305 of FIG. 3) based on the indices to determine the weight tensor. As another example, in some aspects, the machine learning system may process the indices using one or more functions (e.g., an affine function if the weight quantization is uniformly distributed) to determine the weights.

In some aspects, as discussed above, the weights (determined using the codebook and/or affine function) may be encoded in a first precision (e.g., eight-bit integer). In some aspects, as discussed above with reference to FIG. 3, these weights are encoded using per-channel quantization (based on constraints applied during the quantization process). In some aspects, as discussed above with reference to FIG. 2, the weights are encoded using per-block quantization (using unconstrained vector quantization techniques).

In some aspects, if the weights are per-block encoded, determining the weight tensor at block 415 may include further operations. For example, in some aspects, the machine learning system may convert the weight tensor using an upscaling operation (e.g., the up-conversion operation 215) to convert the weights from the first precision (e.g., eight-bit integer) and granularity (e.g., per-block encoding) to a second (higher) precision (e.g., sixteen-bit integer or floating point) and second (lower) granularity (e.g., per-channel encoding).

At block 420, the machine learning system can then generate an output tensor for the layer (or other component) of the machine learning model based on the input tensor (accessed at block 405) and the weight tensor (determined at block 415). For example, as discussed above, the machine learning system may perform per-channel matrix multiplication using the weight tensor and input tensor. In some aspects, the output tensor may then be processed using a variety of operations, such as using an activation function, or may be provided directly as input to a subsequent layer (or other component) of the model.

Advantageously, as discussed above, the method 400 enables vector quantization to be implemented without custom kernels on existing hardware components. This can substantially reduce the memory footprint of the model as well as computational expense of executing the model (e.g., using reduced compute time or latency) without relying on custom hardware. This can significantly improve the flexibility and efficiency of a wide variety of machine learning models.

### Example Method for Quantized Machine Learning

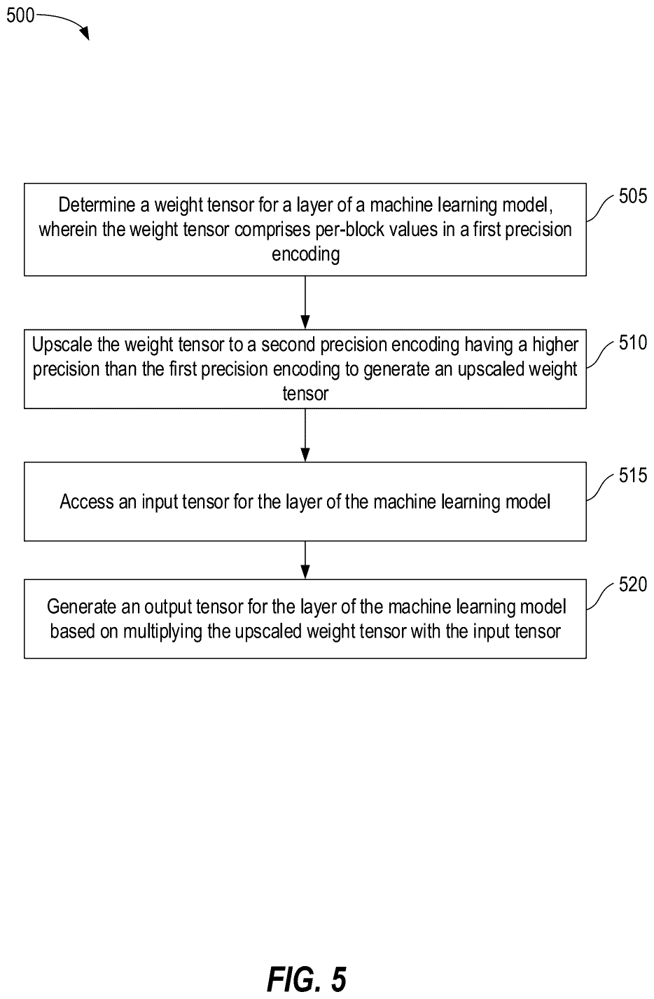

FIG. 5 is a flow diagram depicting an example method 500 for vector quantized machine learning, according to some aspects of the present disclosure. In some aspects, the method 500 may be performed by a machine learning system, such as the machine learning system 110 of FIG. 1, and/or the machine learning system discussed above with reference to FIG. 2, FIG. 3, and/or FIG. 4.

At block 505, a weight tensor for a layer of a machine learning model is determined, wherein the weight tensor comprises per-block values in a first precision encoding.

At block 510, the weight tensor is upscaled to a second precision encoding having a higher precision than the first precision encoding to generate an upscaled weight tensor.

At block 515, an input tensor for the layer of the machine learning model is accessed.

At block 520, an output tensor for the layer of the machine learning model is generated based on multiplying the upscaled weight tensor with the input tensor.

In some aspects, determining the weight tensor comprises accessing a set of indices for the layer and determining the weight tensor using a codebook and based on the set of indices.

In some aspects, the codebook corresponds to a variational quantization scheme, and each respective index of the set of indices corresponds to a plurality of quantized weights in the codebook.

In some aspects, the codebook comprises the plurality of quantized weights in one or more non-uniform distributions.

In some aspects, determining the weight tensor comprises accessing a set of indices for the layer and determining the weight tensor using an affine function and based on the set of indices.

In some aspects, the first precision encoding comprises integer values encoded using a first bitwidth, and the second precision encoding comprises integer values encoded using a second bitwidth larger than the first bitwidth.

In some aspects, the first precision encoding comprises integer values, and the second precision encoding comprises floating-point values.

### Example Processing System for Quantized Machine Learning

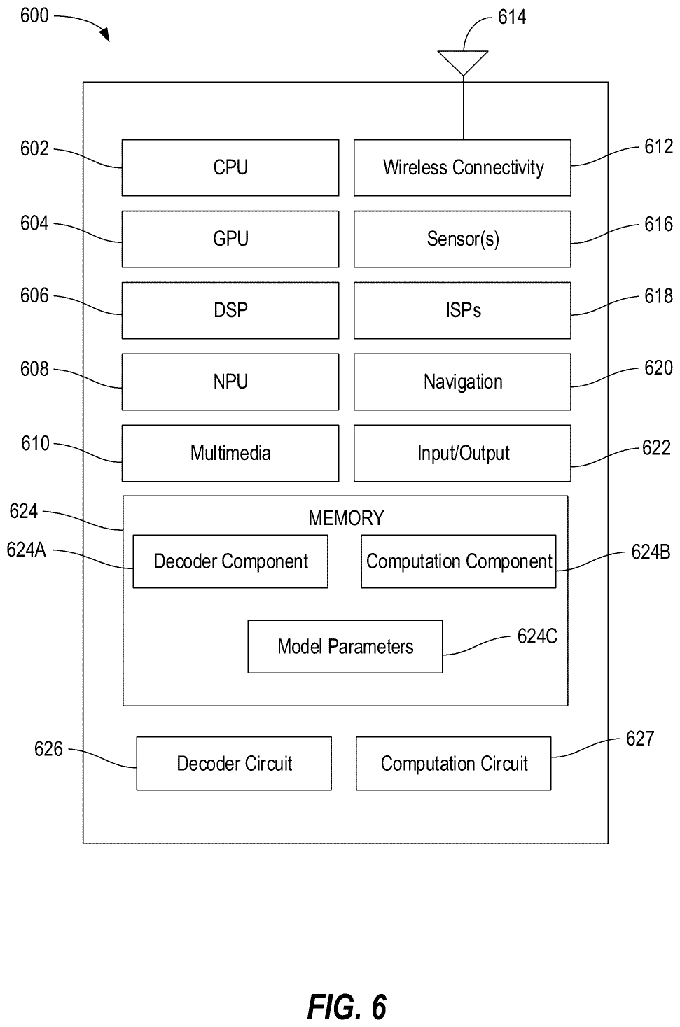

FIG. 6 depicts an example processing system 600 configured to perform various aspects of the present disclosure, including, for example, the techniques and methods described with respect to FIGS. 1-5. In some aspects, the processing system 600 may correspond to a machine learning system. For example, the processing system 600 may correspond to the machine learning system 110 of FIG. 1 and/or the machine learning system discussed above with reference to FIGS. 2-5. Although depicted as a single system for conceptual clarity, in some aspects, as discussed above, the components described below with respect to the processing system 600 may be distributed across any number of devices or systems.

The processing system 600 includes a central processing unit (CPU) 602, which in some examples may be a multi-core CPU. Instructions executed at the CPU 602 may be loaded, for example, from a program memory associated with the CPU 602 or may be loaded from a memory partition (e.g., a partition of a memory 624).

The processing system 600 also includes additional processing components tailored to specific functions, such as a graphics processing unit (GPU) 604, a digital signal processor (DSP) 606, a neural processing unit (NPU) 608, a multimedia component 610 (e.g., a multimedia processing unit), and a wireless connectivity component 612.

An NPU, such as the NPU 608, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 608, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 608 is a part of one or more of the CPU 602, the GPU 604, and/or the DSP 606.

In some examples, the wireless connectivity component 612 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 612 is further coupled to one or more antennas 614.

The processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS) as well as inertial positioning system components.

The processing system 600 may also include one or more input and/or output devices 622, such as screens, touch-sensitive surfaces (including touch-sensitive displays), physical buttons, speakers, microphones, and the like.

In some examples, one or more of the processors of the processing system 600 may be based on an ARM or RISC-V instruction set.

The processing system 600 also includes a memory 624, which is representative of one or more static and/or dynamic memories, such as a dynamic random access memory, a flash-based static memory, and the like. In this example, the memory 624 includes computer-executable components, which may be executed by one or more of the aforementioned processors of the processing system 600.

In particular, in this example, the memory 624 includes a decoder component 624A and a computation component 624B. Although not depicted in the illustrated example, the memory 624 may also include other components, such as an inferencing or generation component to manage the generation of output data using machine learning models, a training component used to train or update the machine learning model(s), a quantization component used to quantize the machine learning models, and the like. Though depicted as discrete components for conceptual clarity in FIG. 6, the illustrated components (and others not depicted) may be collectively or individually implemented in various aspects.

Further, in the illustrated example, the memory 624 also includes a set of model parameters 624C (e.g., parameters of one or more machine learning models, such as the weight tensor 130 of FIG. 1). Although not included in the illustrated example, in some aspects, the memory 624 may also include various other data, such as codebooks (e.g., the codebook 205 of FIG. 2 and/or the codebook 305 of FIG. 3), affine functions, indices (e.g., the indices 125 of FIGS. 1-3), and the like.

The processing system 600 further comprises a decoder circuit 626 and a computation circuit 627. The depicted circuits, and others not depicted (such as an inferencing circuit), may be configured to perform various aspects of the techniques described herein.

The decoder component 624A and/or the decoder circuit 626 (which may correspond to the decoder component 120 of FIGS. 1-3) may be used to generate or determine weight tensors (e.g., the weight tensors 130 of FIG. 1, 130A of FIG. 2, and/or 130B of FIG. 3) based on indices, as discussed above. For example, the decoder component 624A and/or the decoder circuit 626 may process the indices using a codebook or affine function to identify one or more weight(s) corresponding to each index.

The computation component 624B and/or the computation circuit 627 (which may correspond to the computation component 135 of FIGS. 1-3) may be used to compute output tensors based on input tensors and/or weight tensors, as discussed above. For example, the computation component 624B and/or the computation circuit 627 may use matrix multiplication to generate output tensors for each layer or other component of the model. In some aspects, as discussed above with reference to FIG. 2, the computation component 624B and/or the computation circuit 627 may further transform the weight tensor (determined by the decoder component 624A and/or decoder circuit 626), such as to convert the weights from a per-block encoding at a first precision (e.g., eight bit) to a per-channel encoding at a second precision (e.g., sixteen bit).

Though depicted as separate components and circuits for clarity in FIG. 6, the decoder circuit 626 and the computation circuit 627 may collectively or individually be implemented in other processing devices of the processing system 600, such as within the CPU 602, the GPU 604, the DSP 606, the NPU 608, and the like.

Generally, the processing system 600 and/or components thereof may be configured to perform the methods described herein.

Notably, in other aspects, aspects of the processing system 600 may be omitted, such as where the processing system 600 is a server computer or the like. For example, the multimedia component 610, the wireless connectivity component 612, the sensor processing units 616, the ISPs 618, and/or the navigation processor 620 may be omitted in other aspects. Further, aspects of the processing system 600 may be distributed between multiple devices.

### Example Clauses

Implementation examples are described in the following numbered clauses:

Clause 1: A method, comprising: determining a weight tensor for a layer of a machine learning model, wherein the weight tensor comprises per-block values in a first precision encoding; upscaling the weight tensor to a second precision encoding having a higher precision than the first precision encoding to generate an upscaled weight tensor; accessing an input tensor for the layer of the machine learning model; and generating an output tensor for the layer of the machine learning model based on multiplying the upscaled weight tensor with the input tensor.

Clause 2: A method according to Clause 1, wherein determining the weight tensor comprises: accessing a set of indices for the layer; and determining the weight tensor using a codebook and based on the set of indices.

Clause 3: A method according to Clause 2, wherein: the codebook corresponds to a variational quantization scheme, and each respective index of the set of indices corresponds to a plurality of quantized weights in the codebook.

Clause 4: A method according to Clause 3, wherein the codebook comprises the plurality of quantized weights in one or more non-uniform distributions.

Clause 5: A method according to any of Clauses 1-4, wherein determining the weight tensor comprises: accessing a set of indices for the layer; and determining the weight tensor using an affine function and based on the set of indices.

Clause 6: A method according to any of Clauses 1-5, wherein: the first precision encoding comprises integer values encoded using a first bitwidth, and the second precision encoding comprises integer values encoded using a second bitwidth larger than the first bitwidth.

Clause 7: A method according to any of Clauses 1-5, wherein: the first precision encoding comprises integer values, and the second precision encoding comprises floating-point values.

Clause 8: A processing system comprising: a memory comprising processor-executable instructions; and one or more processors coupled to the one or more memories and configured to execute the processor-executable instructions and cause the processing system to perform a method in accordance with any of Clauses 1-7.

Clause 9: A processing system comprising means for performing a method in accordance with any of Clauses 1-7.

Clause 10: A non-transitory computer-readable medium comprising computer-executable instructions that, when executed by one or more processors of a processing system, cause the processing system to perform a method in accordance with any of Clauses 1-7.

Clause 11: A computer program product embodied on a computer-readable storage medium comprising code for performing a method in accordance with any of Clauses 1-7.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system for machine learning comprising:
one or more memories comprising processor-executable instructions; and
one or more processors coupled to the one or more memories and configured to execute the processor-executable instructions and cause the processing system to:
determine a weight tensor for a layer of a machine learning model, wherein the weight tensor comprises per-block values in a first precision encoding;
upscale the weight tensor to a second precision encoding having a higher precision than the first precision encoding to generate an upscaled weight tensor;
access an input tensor for the layer of the machine learning model; and
generate an output tensor for the layer of the machine learning model based on multiplying the upscaled weight tensor with the input tensor.

2. The processing system of claim 1, wherein, to determine the weight tensor, the one or more processors are configured to further execute the processor-executable instructions and cause the processing system to:
access a set of indices for the layer; and
determine the weight tensor using a codebook and based on the set of indices.

3. The processing system of claim 2, wherein:
the codebook corresponds to a vector quantization scheme, and
each respective index of the set of indices corresponds to a plurality of quantized weights in the codebook.

4. The processing system of claim 3, wherein the codebook comprises the plurality of quantized weights in one or more non-uniform distributions.

5. The processing system of claim 1, wherein, to determine the weight tensor, the one or more processors are configured to further execute the processor-executable instructions and cause the processing system to:
access a set of indices for the layer; and
determine the weight tensor using an affine function and based on the set of indices.

6. The processing system of claim 1, wherein:
the first precision encoding comprises integer values encoded using a first bitwidth, and
the second precision encoding comprises integer values encoded using a second bitwidth larger than the first bitwidth.

7. The processing system of claim 1, wherein:
the first precision encoding comprises integer values, and
the second precision encoding comprises floating-point values.

8. A processor-implemented method for machine learning, comprising:
determining a weight tensor for a layer of a machine learning model, wherein the weight tensor comprises per-block values in a first precision encoding;
upscaling the weight tensor to a second precision encoding having a higher precision than the first precision encoding to generate an upscaled weight tensor;
accessing an input tensor for the layer of the machine learning model; and
generating an output tensor for the layer of the machine learning model based on multiplying the upscaled weight tensor with the input tensor.

9. The processor-implemented method of claim 8, wherein determining the weight tensor comprises:
accessing a set of indices for the layer; and
determining the weight tensor using a codebook and based on the set of indices.

10. The processor-implemented method of claim 9, wherein:
the codebook corresponds to a vector quantization scheme, and
each respective index of the set of indices corresponds to a plurality of quantized weights in the codebook.

11. The processor-implemented method of claim 10, wherein the codebook comprises the plurality of quantized weights in one or more non-uniform distributions.

12. The processor-implemented method of claim 8, wherein determining the weight tensor comprises:
accessing a set of indices for the layer; and
determining the weight tensor using an affine function and based on the set of indices.

13. The processor-implemented method of claim 8, wherein:
the first precision encoding comprises integer values encoded using a first bitwidth, and
the second precision encoding comprises integer values encoded using a second bitwidth larger than the first bitwidth.

14. The processor-implemented method of claim 8, wherein:
the first precision encoding comprises integer values, and
the second precision encoding comprises floating-point values.

15. A processing system, comprising:
means for determining a weight tensor for a layer of a machine learning model, wherein the weight tensor comprises per-block values in a first precision encoding;
means for upscaling the weight tensor to a second precision encoding having a higher precision than the first precision encoding to generate an upscaled weight tensor;
means for accessing an input tensor for the layer of the machine learning model; and
means for generating an output tensor for the layer of the machine learning model based on multiplying the upscaled weight tensor with the input tensor.

16. The processing system of claim 14, wherein the means for determining the weight tensor comprise:
means for accessing a set of indices for the layer; and
means for determining the weight tensor using a codebook and based on the set of indices.

17. The processing system of claim 16, wherein:
the codebook corresponds to a variational quantization scheme, and
each respective index of the set of indices corresponds to a plurality of quantized weights in the codebook.

18. The processing system of claim 14, wherein the means for determining the weight tensor comprise:
means for accessing a set of indices for the layer; and
means for determining the weight tensor using an affine function and based on the set of indices.

19. The processing system of claim 14, wherein:
the first precision encoding comprises integer values encoded using a first bitwidth, and
the second precision encoding comprises integer values encoded using a second bitwidth larger than the first bitwidth.

20. The processing system of claim 14, wherein:
the first precision encoding comprises integer values, and
the second precision encoding comprises floating-point values.
